(19) United States
(12) Patent Application Publication
(10) Pub. No.: US 2025/0170000 A1
(43) Pub. Date: May 29, 2025

(54) Stretcher Weather/Privacy Hood

(71) Applicant: Stephen Larivee, West Yarmouth, MA (US)

(72) Inventor: Stephen Larivee, West Yarmouth, MA (US)

(21) Appl. No.: 18/523,722

(22) Filed: Nov. 29, 2023

(51) Int. Cl. A61G 1/04; E04H 15/02; E04H 15/48; E04H 15/54

(52) U.S. Cl. CPC A61G 1/04; E04H 15/02; E04H 15/48; E04H 15/54

(57) ABSTRACT

A protective cover for the head section of stretchers and gurneys wherein the stretcher hood is formed by angular cross members, both for the upper and lower framework as well as others which are attached to a hinged connector on each side. The cover is collapsible by moving the uppermost frame back and downwards against the lower most frame, and deployable by moving the uppermost frame upward in the opposite direction.

### TECHNICAL FIELD

The present subject matter generally relates to the field of medical transport, and to mechanical transportation stretchers used in ambulances and similar patient transportation devices. For the sake of this patent application the terms stretcher and gurney are/may be used interchangeably.

US CPC Class (including but not limited to) A61G 1/04, A47C 29/003, A61G 7/00, A61G 7/1073, A61G 7/0513

### BACKGROUND

A stretcher is a platform used for transporting, or otherwise moving, patients from one location, typically a field location or accident scene, to another that can provide an elevated level(s) of medical care. They are fully adjustable up and down, able to roll on large wheels and there is also an adjustable section to elevate the torso into a lounge/sitting position, with the legs remaining outstretched horizontally. They are typically rolled into an ambulance until just the head section of the stretcher is supported by the ambulance floor. Then as the foot section is supported by one or two persons, the wheel assembly underneath is retracted and the whole unit is then slid/rolled into the ambulance and locked into place.

Being as transportation is the primary function of the stretcher, the inherently open design offers no protection from the elements including, but not limited to, precipitation and wind, nor privacy from the inevitable onlookers and photo-takers present at an accident scene or initial patient location. While there have been attempts at providing such protection, they have been met with limited success due to a) impediments to the working area created by such coverings as they typically cover the length of the flattened stretcher from one side to the other, or b) limit ventilation afforded around the patient, or c) lack the ability for removal and installation in the field in an easy manner without tools, or d) lack the ability to maintain a clean and sterile environment as the materials previously used tend to absorb contaminants rather than repel them. This leaves medical personnel to provide such protection from gawkers and onlookers by shielding them with their bodies and/or using blankets to add protection from elements.

Thus, there exists a need for a protective cover to provide such protection and privacy while the patient is being transported while at the same time not being an impediment to either the equipment, equipment accessories such as attached oxygen tanks etc. or impeding patient access. This device would attach to the upper tiltable section of the stretcher mattress frame allowing unimpeded movement of that section without removing the attached cover. It could also be left on the stretcher in the closed position thereby keeping the stretcher largely in its original unprotected condition while allowing it to be instantly deployed without any time-consuming attachment procedure. The covering would be a water repellant material, of better quality and durability than canvas, that could be changed out in the field over time negating the need for replacing the entire assembly in the event of cover damage due to unforeseen actions, or from normal wear and tear over extended periods of time. Multiple color choices can be offered.

### SUMMARY OF THE INVENTION

A protective cover for the head section of stretchers and gurneys is fitted to provide protection from the elements while transporting patients to and from hospitals and ambulances. It additionally provides a measure of privacy for the patients allowing the transporting entity to adhere to HIPAA (Health Insurance Portability and Accountability Act 1996) regulations protecting patient confidentiality, while at the same time allowing full view of the patient by medical personnel during transport.

The stretcher hood is formed by angular cross members, both for the upper and lower framework as well as others which are attached to a hinged connector on each side. An exterior grade material, superior to canvas in its maintainability and cleaning ability is attached over the framework to form the protective weather/privacy hood. It is collapsible by moving the uppermost frame back and downwards against the lower most frame, and deployable by moving the uppermost frame upward in the opposite direction.

It will attach to the stretcher head section by C-type clamps that attach at one side to the stretcher frame and the other to the protective hood frame. In this manner it is easily both attached and removed in the field. Further, as it attaches to the upper movable frame of the stretcher, it would not impede that stretcher section's movement, nor the application of medical equipment to the back side of the mobile portion of the stretcher. This will allow the invention to always remain attached, whether it is deployed or not. It can also be easily unattached with no tools and by person(s) in the field.

The differences between this model and others in the patent arena are several and make for a vastly improved design are as follows:

Materials—While previous models used basic canvas, this proves hard to maintain for longevity and even harder to clean. This improved model is made with a cover material called Weblon manufactured by Herculite®. An exterior grade material that holds color, does not rely on a performance finish that wears off over time and most importantly, lends itself to cleaning between patients. It features a strong polyester base with manageable weight for excellent dimensional stability ensuring that it will stay waterproof and tight on the frame. It is fire retardant as well as UV, water and mildew resistant. It is also heat sealable for a strong waterproof and airtight seat. It can be cleaned with disinfectants such as bleach and other chemicals without voiding the warranty of the material.

Isinglass windows to maintain a clear view of patient. There are windows across the top and back panels of the stretcher cover that allow transport personnel to maintain a constant view of the patient during critical phases of transport. These windows are fabricated from Isinglass. They are attached via Velcro fastenings allowing for easy replacement over time should the windows suffer the possibility of hazing, scratching or other damage created in harsh field environments. Replacement windows will thus be offered, separate from the frame assembly, making such changes practical, easy and affordable.

The cover attaches to the frame with Velcro fastening material. This will allow for easy change-out in the field should the material become damaged for whatever reason. Replacement covers will thus be offered, separate from the frame assembly, making such changes practical, easy and affordable.

Openings to the material at lower frame attach points. This will have a two-fold benefit to the design. Firstly, it will allow continued ventilation to the patient during transport. Secondly, the frame construction will be of a design that has a separable centerpiece. Such a design will allow for the unit to be adjustable for varying widths, thereby allowing attachment to a variety of stretcher designs should they vary from one manufacturer to another. It will also allow for easy separation of the stretcher cover from the stretcher frame.

Multiple sized attach points. The entire assembly will attach to the stretcher with firm, yet flexible clamps to both the stretcher cover frame and the stretcher frame itself thereby allowing attachment to a variety of stretcher designs should they vary from one manufacturer to another.

Wider design. Current designs shown in patent searches reveal impractical designs that never made it to production due to several reasons negated here. One such reason is the fact that they were too small and restricting. This design is improved upon since the base frame has extensions that are built into the design that allow for an extra 75 mm (3″) per side for a total of 150 mm (6″) outside of the standard frame width of 339 mm (15 11/16″)

Frame Release Clamp. The lower frame of the stretcher cover is fitted with a release clamp that allows the two bifurcations of the frame to be separated allowing the attaching clamps to be released from the frame of the stretcher.

Canted head piece. The head sections of the upper and lower frames are canted upward and forward respectively to allow for additional protection without adding to the mass of the frame.

Powder coating to framework. This will ensure longevity and durability, as well as create the ability to match the existing stretcher frame color scheme.

### BRIEF DESCRIPTION OF DRAWINGS

FIG. 1 shows a top view of the stretcher weather/privacy hood.

FIG. 2 shows a perspective view of the stretcher weather/privacy hood.

FIG. 3 shows a side view of the stretcher weather/privacy hood.

FIG. 4 shows a front view of the stretcher weather/privacy hood.

FIG. 5 shows a perspective view of the stretcher weather/privacy hood.

FIG. 6 shows a front perspective view of the stretcher weather/privacy hood's frame in the collapsed position.

FIG. 7 shows a back perspective view of the stretcher weather/privacy hood's frame in the collapsed position.

FIG. 8 shows a back perspective view of the stretcher weather/privacy hood's transparent windows.

FIG. 9 shows a perspective view of the stretcher weather/privacy hood's lower locking frame.

FIG. 10 shows a side view of the stretcher weather/privacy hood's frame locking hinge and forward hinge point.

FIG. 11 shows a perspective view of the stretcher weather/privacy hood's frame locking hinge.

FIG. 12 shows a perspective view of the stretcher weather/privacy hood's forward hinge point.

FIG. 13 shows a top view of the stretcher weather/privacy hood's frame in the collapsed position.

FIG. 14 shows a perspective view of the stretcher weather/privacy hood's frame in the collapsed position.

FIG. 15 shows a side view of the stretcher weather/privacy hood's frame in the collapsed position.

FIG. 16 shows a front view of the stretcher weather/privacy hood's frame in the collapsed position.

FIG. 17 shows a top view of the stretcher weather/privacy hood with dimensions.

FIG. 18 shows a perspective view of the stretcher weather/privacy hood frame in the deployed position without a covering.

FIG. 19 shows a right side view of the stretcher weather/privacy hood with dimensions and in the deployed position.

FIG. 20 shows a front view of the stretcher weather/privacy hood with dimensions and in the deployed position.

### DETAILED DESCRIPTION OF THE INVENTION

The purpose of the present subject matter is to provide first responders and medical transport personnel with a means of adding patient protection from inclement weather, local hazards such as bushes, branches etc., as well as privacy from the inevitable onlookers and gawkers at accident scenes. The unit will be entirely collapsible to fold out of the way of the support personnel, allow the patient to be moved on and off the stretcher, and will provide protection from the sides for privacy while the transparent top and rear section will still allow for full view of the patient for continual monitoring during transport.

Further, the canopy will allow by design the attachment or removal from the stretcher while in the field with no tools required. The installation of the protective canopy would require no modification to the existing stretcher designs.

The present invention is further detailed with respect to the following drawings that are intended to show certain aspects of the invention, but should not be construed as a limit on the practice of the invention, nor as a representative example of the only form of stretcher the invention will apply to, wherein:

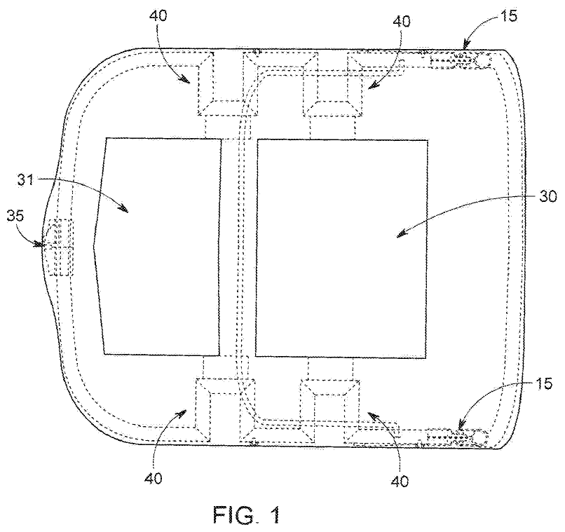

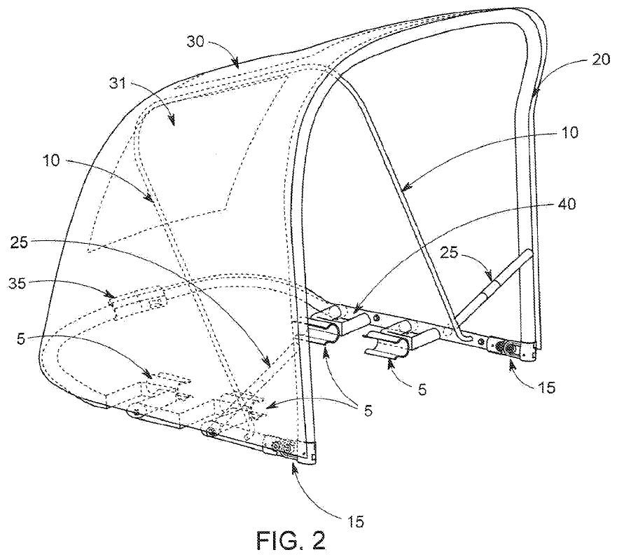

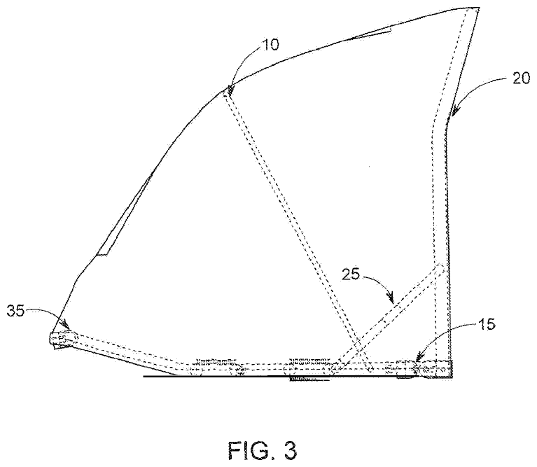

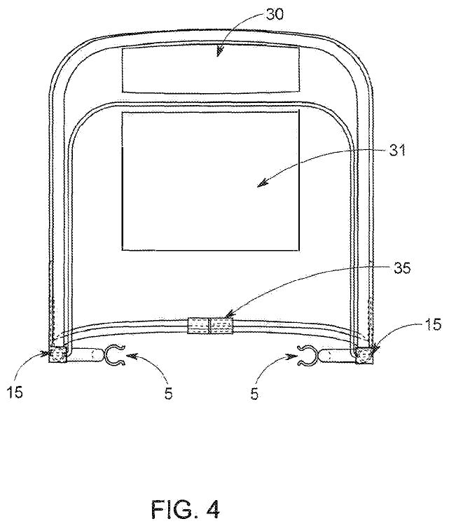

FIG. 1 through FIG. 4 shows series of views showing the stretcher cover in the deployed position. Several components are illustrated. 5 shows the attach clamps that allow the stretcher cover to attach to the stretcher frame. They will allow for pop on/pop off functionality.

10 is the bow support. It is a flexible frame that will allow a support for the cover and runs across from one side to the other, and in between the viewing windows 30, 31. 15 shows the forward hinges that connect the upper and lower frames. 20 shows the point in the upper frame where it angles forward to add a bit more protection while duplicate angle to the lower frame allows access to the frame adjust lever that is a part of the main stretcher construction.

25 is a support bracket that locks into position to keep the cover in the deployed position. 30 represents the upper Isinglass viewing window and 31 represents the rear Isinglass viewing window. These will allow continual observation of the patient during transport. They will attach to the cover by way of Velcro so that they can be easily replaced as needed.

35 represents a rear clamp that can be released and thus allows the bifurcations of the lower frame to expand and more easily facilitate separating the clamps from the stretcher frame by pulling them away. 40 shows the frame extensions that widen the whole stretcher cover past the frame of the stretcher itself. As the average person's shoulders are wider than the stretcher, the cover needed to be wider than the stretcher frame. This allows for that widening.

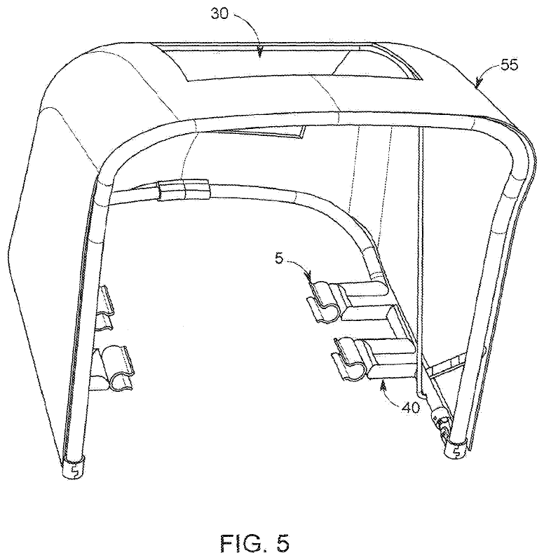

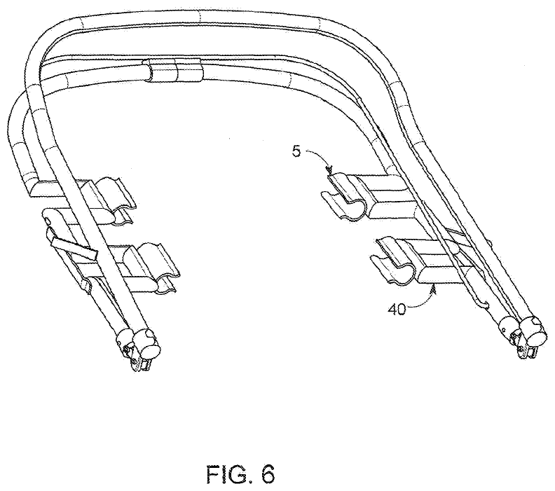

FIG. 5 and FIG. 6 show a perspective view of the protective weather/privacy hood in both the deployed and collapsed positions in accordance with embodiments of the invention. Item 40 represents the location of the 75 mm (3′) extensions to both sides that create a wider interior space more applicable to a larger person's shoulder width. Item 5 represents the C-shaped attach points (4) that clamp the cover to the stretcher frame. Item 55 represents the cover material that surrounds the frame. Item 30 represents one the two (2) clear windows, one (1) across the top and one (1) to the rear allowing transport personnel to maintain visibility of the patient.

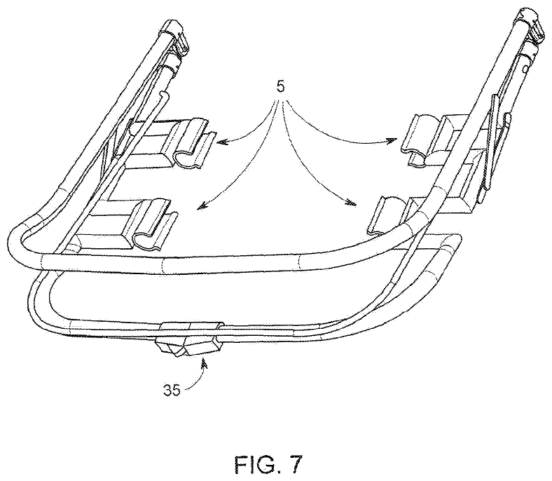

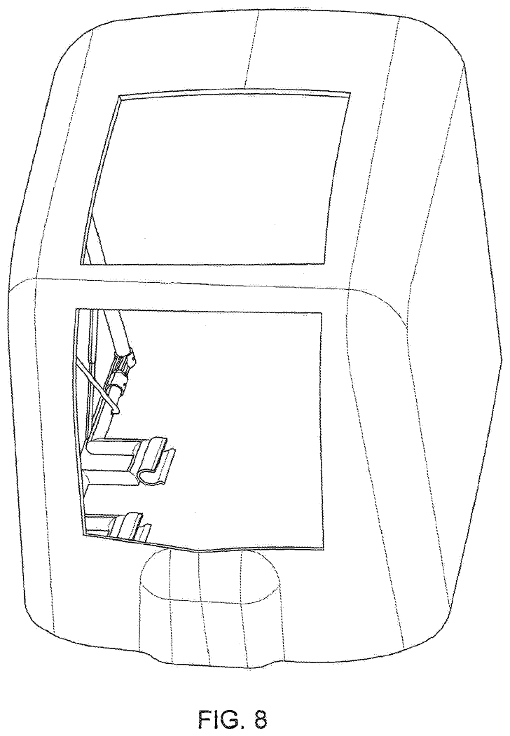

FIG. 7 and FIG. 8 are rear views of the stretcher weather/privacy cover. The right image shows the two transparent windows allowing for continual view of the patient. Notice item 35 is a release clamp. This allows the lower frame to widen and thus allow the clamps 5 to release from the frame of the stretcher.

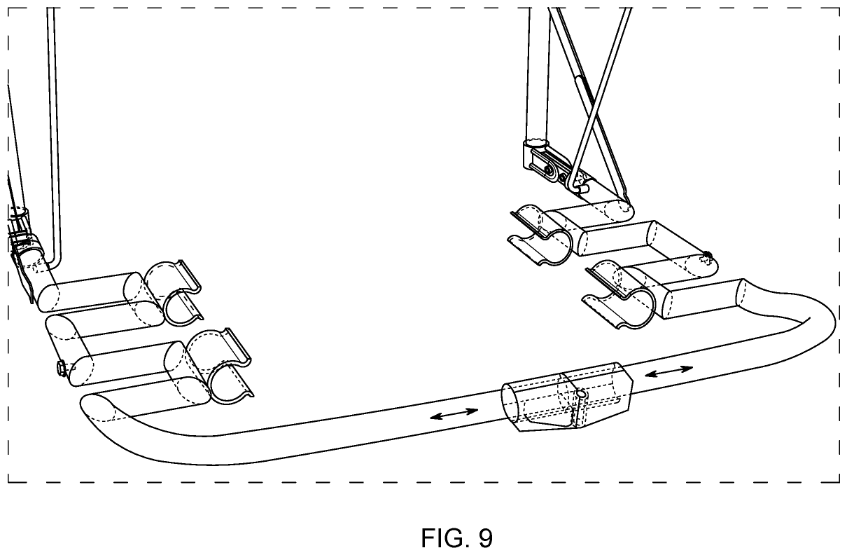

FIG. 9 shows the frame locking hinge that allows the lower frame to separate and pull away from the stretcher frame.

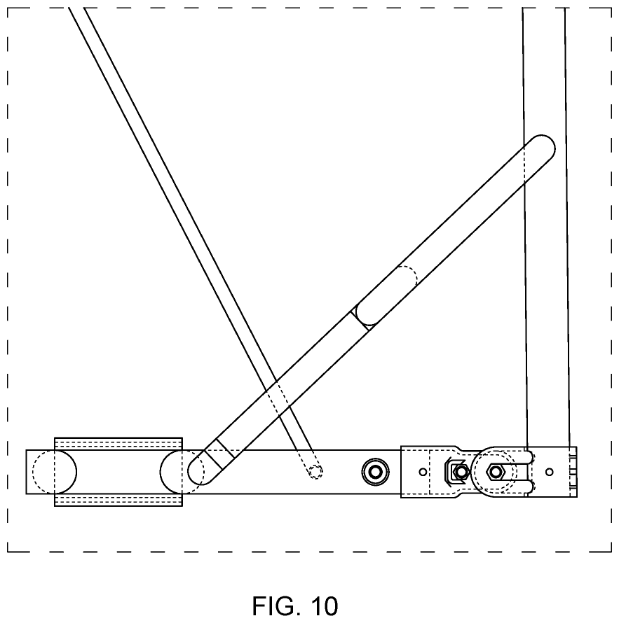

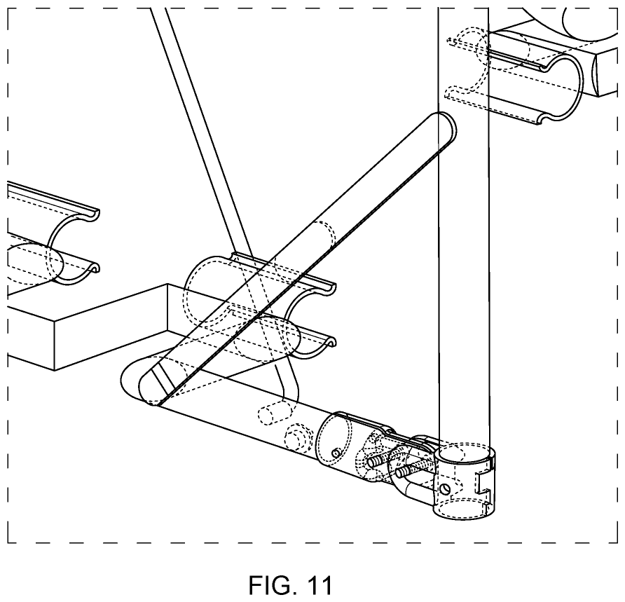

FIG. 10 and FIG. 11 show the forward hinge point of the stretcher cover frame. The hinge component and the attach points of the upper frame and the stretcher cover bow that supports the Weblon cover. This support bow runs across the cover between the two windows.

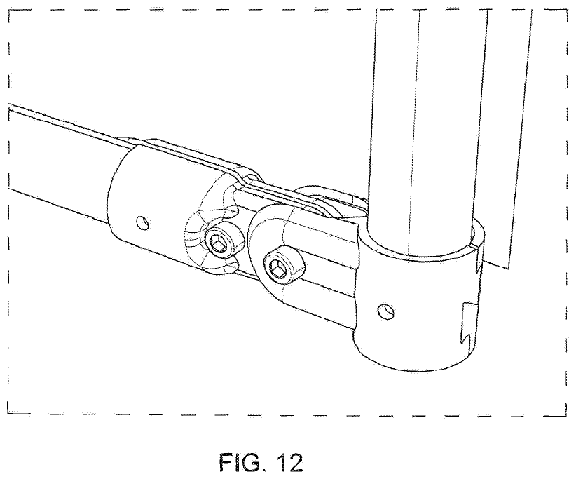

FIG. 12 shows a closeup of the hinge that connects the upper and lower frames. It connects to both by way of sockets and pins and held together with Allen screws. These are consumer replaceable and not intended to be replaced or removed in the field.

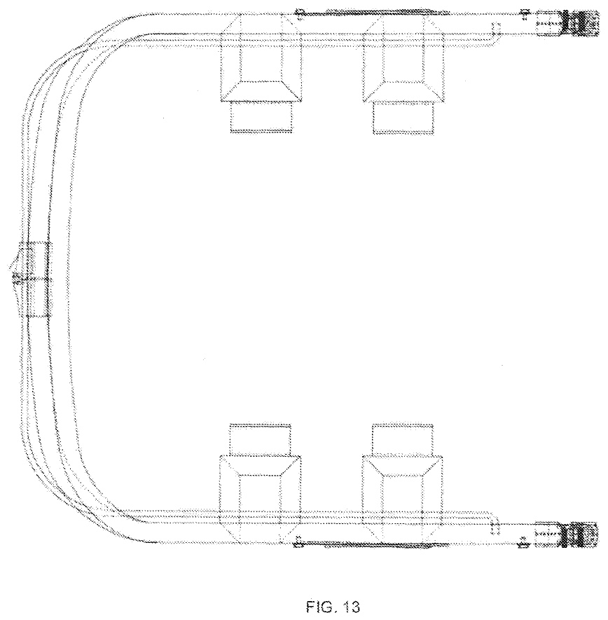

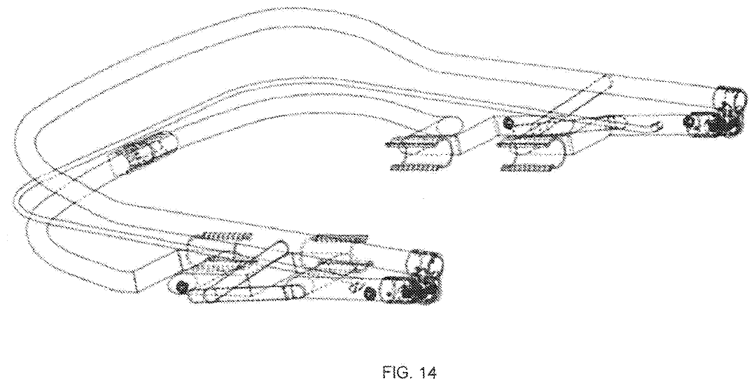

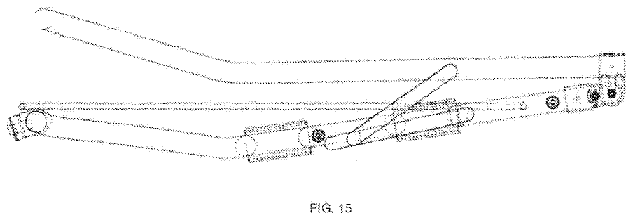

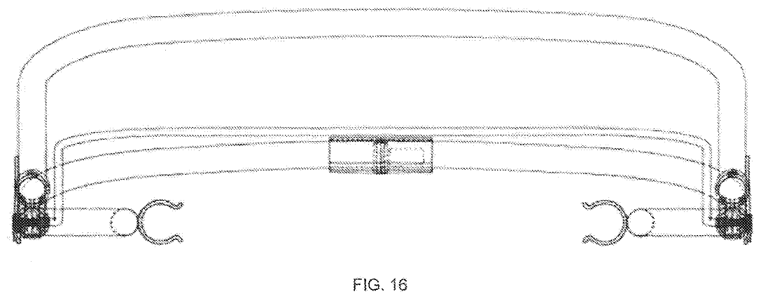

FIG. 13 through FIG. 16 show collapsed views, and the upward angle of the two frames that allow for more coverage and protection in addition to allowing to grasp an adjustment handle on the stretcher frame that allows for tilting the head and torso up into a reclining position.

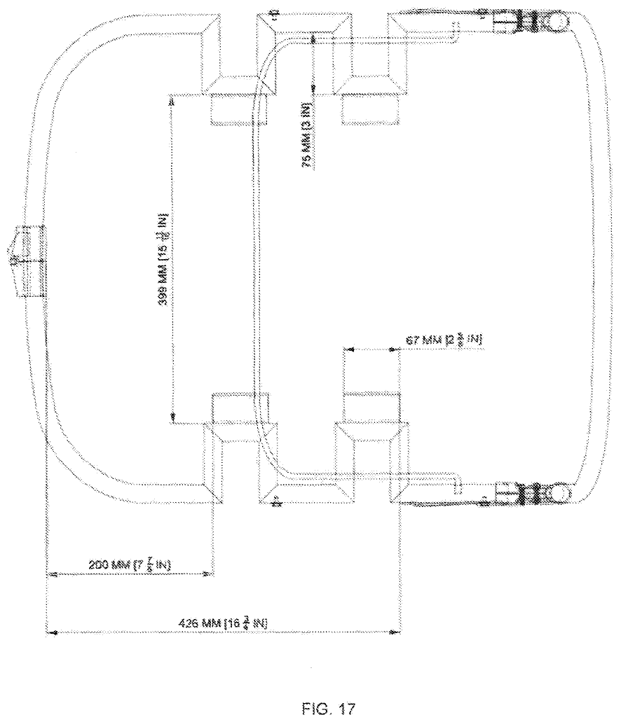

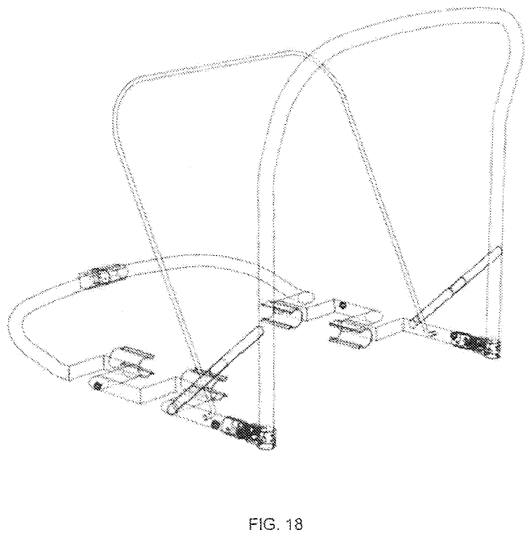

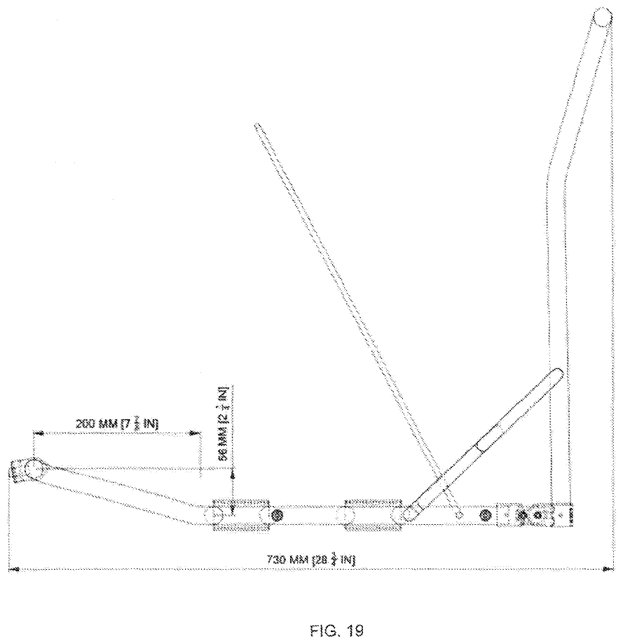

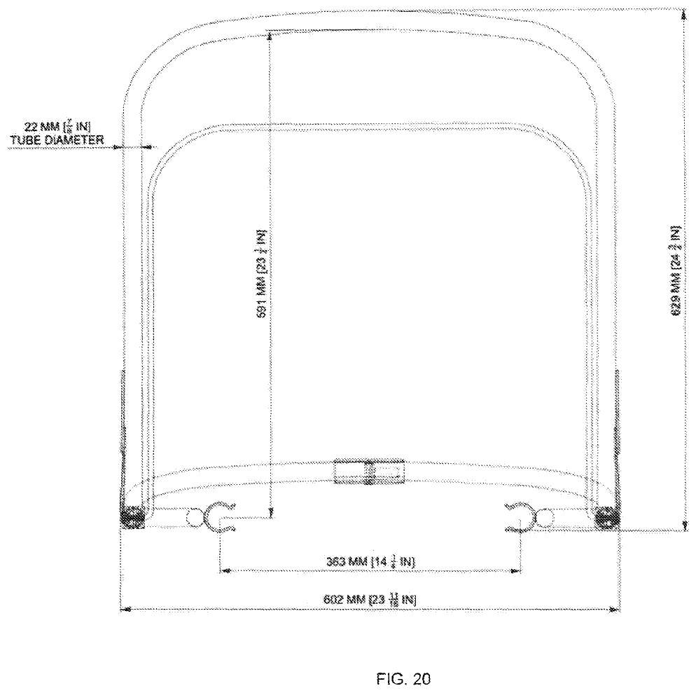

FIG. 17 through FIG. 20 show the stretcher weather/privacy hood with dimensions.

The present subject matter has utility as a protective cover for the head and torso section of stretchers. Embodiments of the inventive protective stretcher cover provide protection from the elements and a measure of privacy to a patient lying on, or sitting in, the stretcher. As used herein, the term stretcher is defined as a generally planar apparatus used for moving patients who require medical care specifically intended to include wheeled versions thereof that are commonly referred to as gurneys.

Embodiments of the protective weather/privacy hood are formed with an upper and lower frame, and a number of independent frames joined with a hinge to each side. Between each of the upper and lower frames, a weatherproof shielding material will be attached to provide the protecting cover over a portion of the stretcher supporting the upper torso of the patient being transported.

Framing material as illustrated may be formed of metal, fiberglass, thermoplastics, thermoset resins, carbon-fiber, or any combination thereof where they will provide rigidity to support the protective cover attached to the frames. It will have a hinging mechanism able to support the arcuate form of the deployed weather/privacy hood. Securements of the covering may include clips, snaps, hooks, zippers, hook and loop fasteners, or a combination thereof. Embodiments of the weather/privacy hood are compact when not deployed and may be folded onto itself above the head end of the stretcher thereby not interfering with the workspace above the patient. It will be deployed and stowed in a minimum of time to prevent interfering with patient treatment.

While one exemplary embodiment has been presented in the foregoing detailed description, it should be appreciated that a vast number of variations exist. It should also be appreciated that the exemplary embodiment or exemplary embodiments are only examples, and thus not intended to limit the scope, applicability, or configuration of the described embodiments in any way. It should be understood that various changes may be made in the function and arrangement of elements without departing from the scope as set forth in the application and legal equivalents thereof.

The following is a list of the relevant parts required to construct the stretcher weather/privacy hood:
One Locking ⅞″ O.D. Tube Hinge.
Two Adjustable Angle Wye 1″ OD Tubes.
Two Locking Support Hinges.
Four Plastic Pipe Snap Connectors.
Four Fabric Snaps.
Three ⅞″ Stainless Tubes.
Support Wire.
Isinglass windows.
Soft Weblon Cover.

1. A stretcher weather/privacy hood comprising of One Locking ⅞″ O.D. Tube Hinge, Two Adjustable Angle Wye 1″ OD Tubes, Two Locking Support Hinges, Four Plastic Pipe Snap Connectors, Four Fabric Snaps, Three ⅞″ Stainless Tubes, Support Wire, and Soft Weblon Cover.

2. The stretcher weather/privacy hood of claim 1, wherein windows across the top and back panels of the stretcher cover that allow transport personnel to maintain a constant view of the patient.

3. The stretcher weather/privacy hood of claim 1, wherein stretcher weather/privacy hood has a soft Weblon cover.

4. The stretcher weather/privacy hood of claim 3, wherein the Weblon cover attaches to the frame with Velcro.

5. The stretcher weather/privacy hood of claim 3, wherein the Weblon material has openings to allow ventilation during transport.

6. The stretcher weather/privacy hood of claim 1, wherein the stretcher weather/privacy hood has multiple sized attach points.

7. The stretcher weather/privacy hood of claim 1, wherein the stretcher weather/privacy hood has base frame extensions.

8. The stretcher weather/privacy hood of claim 1, wherein the stretcher weather/privacy hood has a lower frame of the stretcher cover is fitted with a release clamp that allows the two bifurcations of the frame to be separated.

9. The stretcher weather/privacy hood of claim 1, wherein the head sections of the upper and lower frames are canted upward and forward respectively to allow for additional protection without added mass.

10. The stretcher weather/privacy hood of claim 1, wherein a powder coating to the framework increases durability and the ability to match an existing stretcher's color scheme.
